(19) United States
(12) Patent Application Publication
(10) Pub. No.: US 2023/0358001 A1
(43) Pub. Date: Nov. 9, 2023

(54) ARRANGEMENT IN TRAFFIC SIGN FOR REPLACING PLATE PART

(71) Applicant: INNOTRAFIK OY, Helsinki (FI)

(72) Inventor: Jouni HÄNNINEN, Helsinki (FI)

(21) Appl. No.: 17/918,881

(22) PCT Filed: Apr. 14, 2021
(86) PCT No.: PCT/FI2021/050264

§ 371 Date: Oct. 13, 2022

(30) Foreign Application Priority Data
Apr. 14, 2020 (FI) 20200024

(51) Int. Cl. E01F 9/65; G09F 7/22

(52) U.S. Cl. CPC E01F 9/65; G09F 7/22; G09F 2007/005

(57) ABSTRACT

An arrangement in a traffic sign for replacing a plate part (4) included therein, whereby the traffic sign comprises a plurality of mutually differing plate parts (4a, 4b) of which one at a time may be switched visible and directed on a traffic route. A first body part (1) of the traffic sign, most suitably a vertical post is fixedly installed and has, adapted as an extension by a bearing (11);(12), a second body part (10) which is turnable by means of a power device (7), such as an electric motor, and to said second body part (10) there are connected different plate parts (4a, 4b) directed in different directions, whereby the desired plate part of said plate parts is turnable in the direction of the traffic route by means of said power device, and that the traffic sign includes one or more cover parts (6) that cover those plate parts (4a) or (4b) that are not meant to control traffic.

The invention relates to an arrangement in a traffic sign for replacing a plate part included therein, whereby the traffic sign comprises a plurality of mutually differing plate parts out of which one at a time may be switched visible and directed on a traffic route.

Prior art knows traffic signs in which the plate part intended to be replaced may be turned behind the sign by means of hinges, whereby the blank backside of the plate part becomes visible and from under the turned plate part a different, replacing sign will in turn appear. Such replaceable plate parts have been used as speed limit signs. A drawback with these is that replacing a sign requires a visit to the site, often a personnel hoist, too, if the signs are of the hanging type or have been provided with a longer than normal post due to the terrain.

Furthermore, hinged plate parts are known in traffic signs so that part of the plate, such as one half, folds on the sign and from under the folded part one half of a replacing sign emerges, and a second half of the replacing sign appears from the surface of the part folded on the sign. These signs, too, require an on-site visit when the purpose of the sign is to be changed. A further problem is that a sticker on the sign has to be cut in parts.

It is also known to form numbers on a traffic sign, a speed liming sign, in particular, by means of light patterns. Such signs may be varied by remote-controllably. These signs get damaged easily and are usually suitable for replacing numbers on such signs that relate to changing numbers.

With the arrangement according to the invention, a new advantageous way for replacing traffic signs is achieved. Any sign is easily replaceable with any other sign of a different kind. However, most suitably e.g between round signs or between triangular signs. The arrangement according to the invention is characterised in that a first body part of a traffic signs, most suitably a vertical post, is fixedly installed and thereto is adapted, by means of bearings, a second body part as an extension, turnable with a power device such as an electric motor, and to said second body part there are attached different plate parts directed to different directions.

An advantage of the inventive arrangement is that a proper whole plate part may be swapped without folds, without cutting the sticker foil, or lighting technology for a second genuine and whole plate part without an on-site visit. For example, a round sign may be substituted for any round sign with any colouring. A speed limit sign, for example, may be alternated with a sign prohibiting parking. The sign change most suitably takes place with remote control, whereby it does not matter even if the sign were replaced each day. The sign body is turned electrically and due to a cover part as the back, the backside of the sign does not show any sign.

In the following, the invention will be described in greater detail with reference to the attached drawing, in which

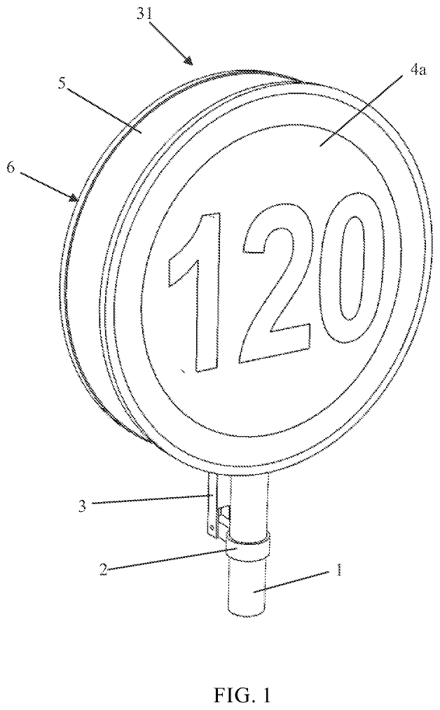

FIG. 1 shows a diagonal view of a traffic sign according to the invention.

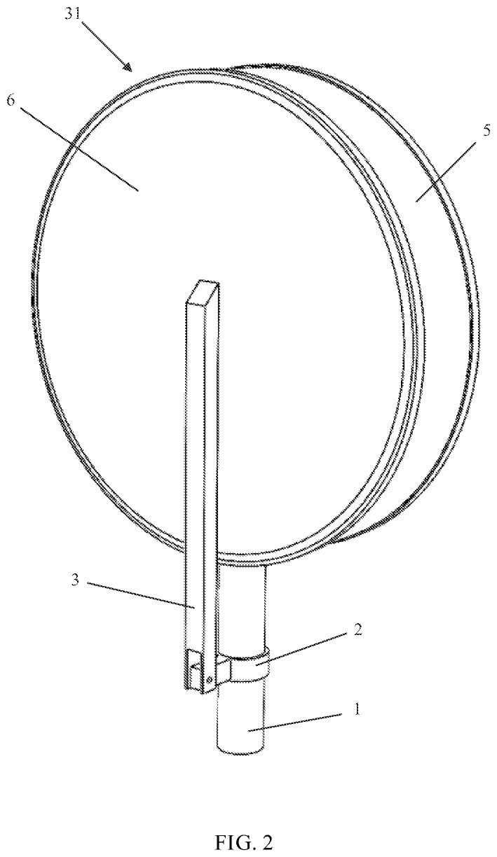

FIG. 2 is a diagonal rear view of the traffic sign of FIG. 1.

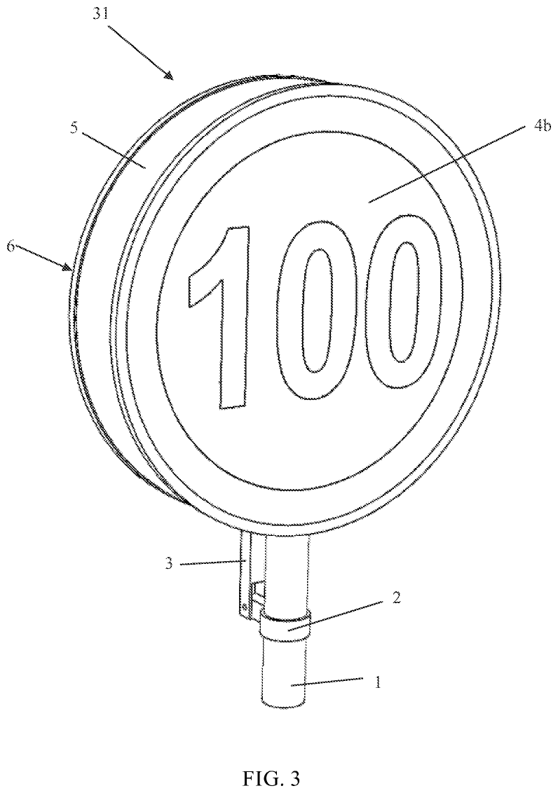

FIG. 3 shows the traffic sign of FIG. 1 turned by 180°.

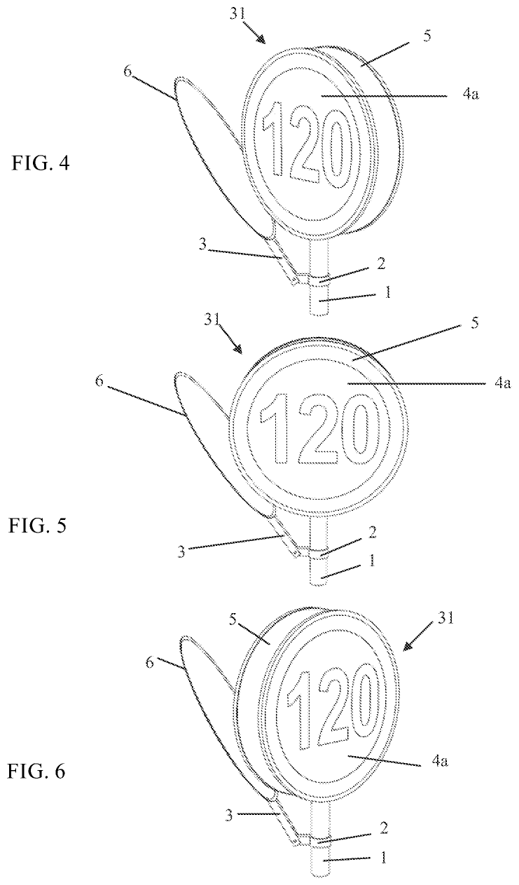

FIGS. 4 to 6 show turning the top part and a withdrawing movement of the cover part of the traffic sign.

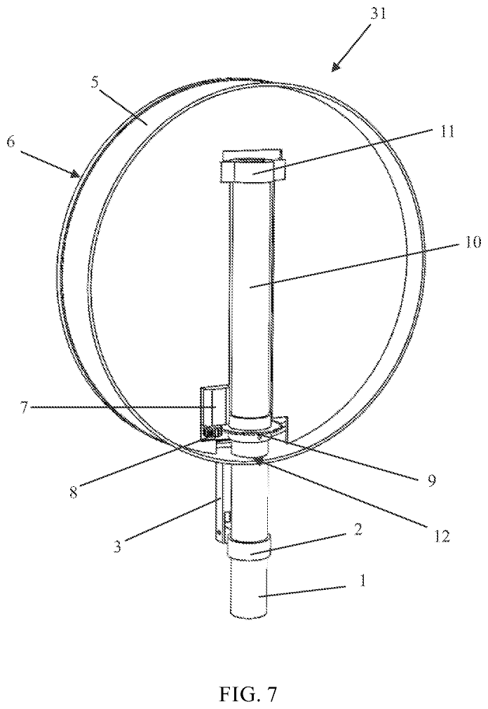

FIG. 7 shows an inner part of the traffic sign in an intermediate space between the plate parts.

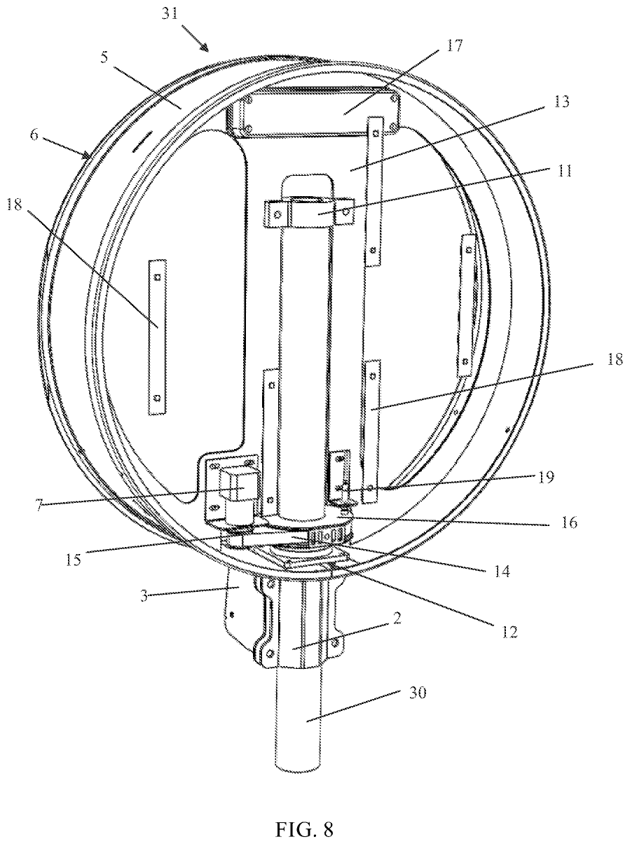

FIG. 8 shows an inner part of the traffic sign according to an example in an intermediate space of the plate parts.

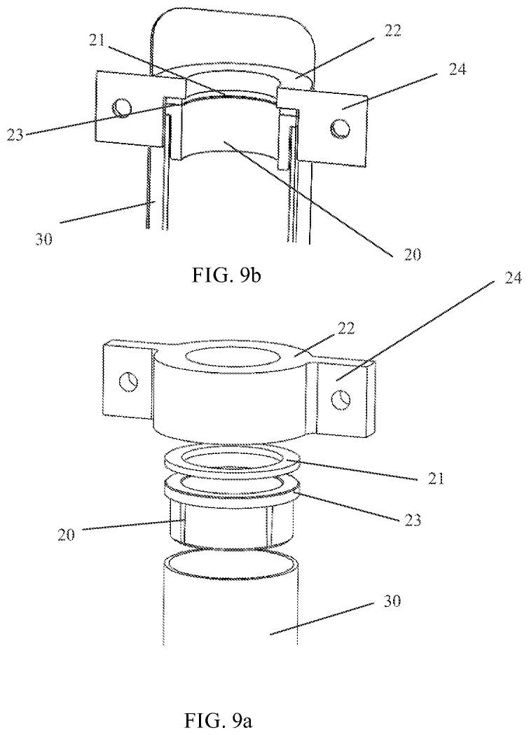

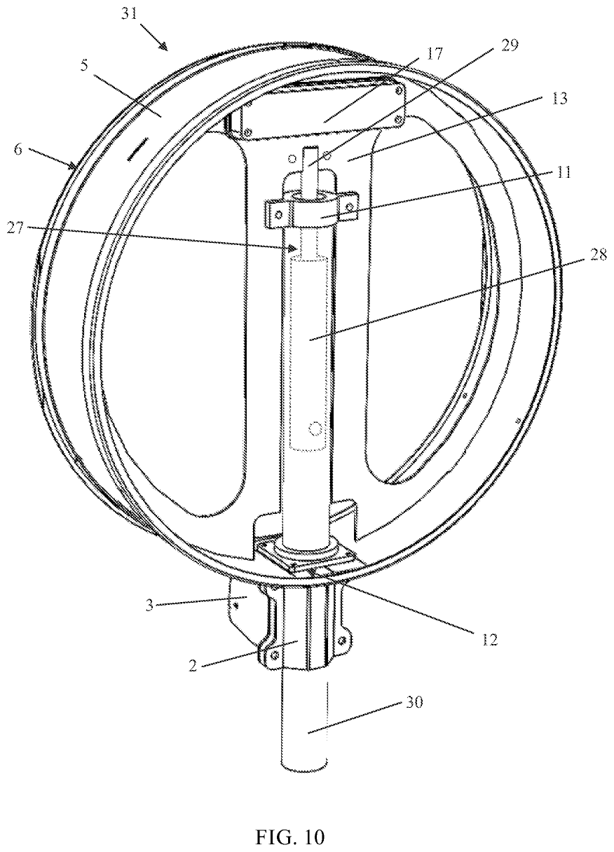

FIG. 9a shows a slide bearing of a traffic sign according to an example.

FIG. 9b shows an exploded view of the slide bearing of the traffic sign shown in FIG. 9a.

FIG. 10 shows an inner part of the traffic sign according to an example in an intermediate space of the plate parts.

FIG. 1 presents an arrangement according to the invention, where plate parts on opposite sides of the sign change places. The traffic sign has as its arm part a fixed first body 1 which continues inside the flat plate part. To the first body part 1, a second body part 10 is adapted as an extension by means of bearings 11, 12. The second body part 10 may be adapted on the inner or outer side of the first body part 1. In the plate part 30, the plate part 4a is visible as a speed limit sign. On the opposite side of the flat part, there is, out of sight, a second replaceable plate part 4b and, covering it, a cover part 6. The plate parts are joined by a band 5, due to which an intermediate space forms between the plate parts. The cover part 6 is fixed to the first body 1 by means of a fastening part 2 and arm 3.

FIG. 2 shows the traffic sign from the rear, whereby the cover part 6 blocks the showing of any sign rearward. The cover part 6 may withdraw rearward, so that the flat sign unit has room to turn 180° around the vertical axis, as shown in FIGS. 4 to 6. It is advantageous that the cover part 6 yields and withdraws to the extent that the sign unit is able to perform its turning move. In an embodiment, in connection with the arm 3 and fastening part 2, there is a spring member that allows the cover part 6 to retreat, the sign unit to turn, and then return the cover part 6 against the concealed plate part. Instead of the spring member, the operation of the cover part 6 may be controlled e.g. by means of a counterweight or a mechanical movement during the turning motion of the sign.

FIG. 3 is a front view of a traffic sign when it has been turned by 180° so that 120 has been replaced with the value 100. The plate part 4a is concealed and the plate part 4b is visible.

FIGS. 4 to 6 show the turning of the sign unit in three different phases. In this embodiment, as the sign unit turns, it also starts to turn the cover part 6 into a retreating position. An edge of the sign units trails the cover part 6 when pushing it to retreat. There may be a small slide piece of e.g. Teflon installed at the edge of the sign unit. The spring member of the cover part 6 returns the cover part against the plate part 4b.

FIG. 7 offers a view to the inside of the sign unit with the plate part 4a removed. Inside the plate part, a lower bearing 12 and upper bearing 11 of the second body part 10 settle. The plate parts 4a, 4b are attached to the upper body 10 in a suitable manner so that they, too, turn as the upper body 10 turns. In this version, the upper body 10 is turned by an electric motor 7 by means of a cog wheel gear 8, 9. To turn the upper body 10 in relation to the lower body 1, other methods known per se may be used.

Inside the sign unit is placed at least reception of signals used for the turning control of a traffic sign. The sign may be adapted to receive signals from various sources such as a car, user devices of various kinds such as phones, through a cloud service or from a remote controller. The traffic sign may be adapted to receive a signal, and based on the signal to turn the traffic sign, activate lighting, alarm signal, and/or alarm light in the traffic sign. Further, equipment needed to ensure turning in winter time, such as the equipment required by heating/de-icing. Because electricity needs to be supplied to the traffic sign either from the electrical network of by means of solar or wind collectors, other sensors, cameras, data transmitters, alarms of fault situations, receivers of warnings, may be adapted in connection with such a traffic sign, and generally speaking features implementable with electricity.

Even though the drawings show a traffic sign with two interchangeable plate parts, a combination of three different plate parts is possible to implement, of which two plate parts are covered and one is shown in the traffic direction. In this case, turning takes place with an angle of 120 degrees instead of 180 degrees.

The example of FIG. 8 shows an arrangement of a traffic sign with a view from the inside of the traffic sign with the plate part 4a removed. According to an exemplary embodiment, the traffic sign comprises a base post 30 to which a sign part 31 is fixed. The sign part may comprise at least two plate parts 4a, 4b. The at least two plate parts 4a, 4b of the sign part 31 may be joined by a band 5, forming an intermediate space between the plate parts 4a, 4b. The sign part 31 may be adapted to be passed onto the base post 30 from above through a hole in the bottom of the sign part 31. The hole in the bottom of the sign part 31 may be in the band 5 and comprise a bearing 12. The sign part 31 may be turnably fastened to the base post 30 by means of an upper bearing 11 and lower bearing 12 whereby the sign part 31 is able to turn around the base post 30. The sign part 31 and the at least two plates 4a, 4b residing therein may be turned with the aid of a power device such as an electrical motor 7 or tubular motor 27.

According to an embodiment, there is a sign part 4b at the rear part of the sign part 30 and, covering it, a cover part 6 which is attached to the body part 30 by means of the arm 3 and fastening part 2. The cover part 6 allows the sign to be seen rearward. The cover part 6 may withdraw rearward so that the sign part 31 has room to turn 180° around the vertical axis, as shown in FIGS. 4 to 6. It is advantageous that the cover part 6 yields and gives way to such an extent that the sign part 31 may perform its turning movement.

According to an exemplary embodiment, the turning of the sign part 31 takes place by means of a power device and power transmission system. The power transmission system may comprise e.g. the cog wheel gear 8, 9 shown in FIG. 7, a belt system shown in FIG. 8, or a pneumatic, hydraulic, or chain system. Other suitable system may also be used to turn the sign part 31.

The belt system according to the example shown in FIG. 8 comprises a gear 15, disc 16, and belt 14. The gear 15 may be in contact with a power device such as an electric motor 7. The disc 16 may be adapted to be fastened to the base post 30. The disc 16 may be fixedly fastened to the base post 30 whereby it cannot turn around the base post 30. The disc 16 may be manufactured of e.g. aluminium or plastic and the gear 15 of aluminium. The electric motor 7 may be adapted to rotate the gear 15 which is in contact with the disc 16 by means of the belt 14, whereby the sign part 31 may be turned around the base post 30. This way the at least two sign parts 4a, 4b may be turned. A belt system is durable, simple to manufacture and install, and its tightness is additionally easy to adjust.

According to an embodiment, the traffic sign additionally comprises a sensor 19 by means of which it is made sure that the traffic sign turns precisely the desired amount whereby it will always be placed in the correct position. The sensor 19 may operate magnetically.

According to an exemplary embodiment, the sign part 31 may comprise a support structure 13 to which the band 5 is attached. The electric motor 7 may also be attached to the support structure 13.

As shown in the example of FIG. 8, inside the sign part 31, in the space formed by the plate parts 4a, 4b and band 5, systems of different kinds are fixed, such as a lighting system to illuminate the traffic sign by means of at least one LED strip 18. Within the sign part 31, it is also possible to house a heater and thermostat which enables a long service life for the batteries, prevents frost formation, freezing, and snow buildup on the traffic sign. The control system 17 may be attached inside or outside the traffic sign to control the different features of the traffic sign, such as turning the traffic sign, operation of the motor 7 and sensor 19, lighting, heating, or other features.

According to an embodiment, the bearing 11, 12 may comprise a sliding, ball, needle, or conical bearing. The example according to FIG. 9a comprises a sliding bearing which comprises a sleeve 20, washer or shim 21, and sleeve pin or sliding part 22. The sliding bearing according to the example of FIGS. 9a and 9b may be installed e.g. at an end of the body part 30 or the traffic sign, as shown in FIGS. 7, 8, and 10. The sleeve 20, washer 21, and sliding part 22 may be manufactured of plastics, metal, aluminium, or another suitable material. The sleeve 20 may be adapted to be installed within the top end of the base post 30 so that an outward-turned edge 23 at the top edge of the sleeve 20 rests on the top edge of the base post 30. The edge 23 may prevent the sleeve 20 from falling entirely inside the base post 30, acting at the same time as a sliding surface. A washer 21 may be adapted on the sleeve 20, and the sliding part 22 on it. The edge 23 of the sleeve 20 and the washer 21 remain inside the sliding part 22 when it is being adapted on the top part of the base post 30.

According to an exemplary embodiment, the sliding part 22 comprises protrusions 24 having holes by means of which the sliding part 22 is adapted for attachment to the sign part 31. According to an exemplary embodiment, there is a hole in the middle of the sleeve 20, washer 21 and sliding part 22, which allows e.g. running cables inside the base post 30 to the sign part 31. In the example of FIG. 8, the sliding part 22 is fixed to the support structure 13.

According to an exemplary embodiment, the base post 30 may comprise a first and a second body part 1, 10. The first body part 1 may continue inside the sign part 31. The second body part 10 may be adapted outside the first body part 1 and it may turn with the sign part 31. In this case, the disc 16 is fixed to the stationary first body part 1. The sign part 31 may also comprise the second body part 10.

The example of FIG. 10 shows an arrangement of a traffic sign with a view from the inside of the traffic sign with the plate part 4a removed. According to an exemplary embodiment, the traffic sign comprises a base post 30 to which a sign part 31 is fixed. The sign part may comprise at least two plate parts 4a, 4b. The at least two sign parts 4a, 4b of the sign part 31 may be joined by a band 5. The sign part 31 may be adapted to be passed onto the base post 30 from above through a hole in the bottom of the sign part 31. The hole in the bottom of the sign part 31 may be in the band 5 and comprise a bearing 12. The sign part 31 may be turnably fastened to the base post 30 by means of an upper bearing 11 and lower bearing 12 whereby the sign part 31 is able to turn around the base post 30. The sign part 31 and the at least two plate parts 4a, 4b contained by it may be turned by a power device, which power device may be a tubular motor 27.

According to the example of FIG. 10, the arrangement in a traffic sign comprises a base post 30 and a sign part 31 fixed to it. A power device may be adapted to a top end of the base post 30. According to an exemplary embodiment, the power device is a tubular motor 27 comprising a motor part 28 which rotates, by means of a rotating axle, a flange part 29 fixed thereto which is able to turn in relation to the motor part 28. The motor part 28 may be adapted non-rotatably inside the base post 30 whereby the motor part 28 cannot turn inside the base post 30. The motor part 28 may be elongated, and the turning flange part 29 fixed thereto may be non-turnably fixed to the sign part 31. The flange part 29 may be fastened e.g. to the support structure 13. When the motor is running, it may turn the sign part 31 by means of the flange part 29.

According to an exemplary embodiment, the arrangement in a traffic sign according to the preceding embodiments is adapted to be installed as a complete entity to an existing traffic sign post, such as a traffic sign post by a road. According to an exemplary embodiment, the arrangement in a traffic sign comprises a base post 30 and a sign part 31 connected thereto. The base post 30 may be shortened to a suitable length, so that the sign part 31 places itself at a suitable height. Installation may be carried out with an inner or outer sleeve or in another suitable manner. Such a finished traffic sign arrangement may be fast and easily installed on an existing traffic post by a road, which makes the installation of the traffic signs faster and reduces the number of tools needed in the installation work.

According to an exemplary embodiment, the arrangement is adapted for installation on an existing traffic sign post by means of a power device. The power device may be an electrical motor 7 or tubular motor 27. According to an exemplary embodiment, the arrangement in a traffic sign comprises a base post 30 and a sign part 31 connected thereto. At the bottom end of the base post 30, a power device may be fixed, which may adapted on an existing traffic sign post. According to an exemplary embodiment, the power device is a tubular motor 27 comprising a motor part 28 which rotates, by means of a rotating axle, a flange part 29 fixed thereto which is able to turn in relation to the motor part 28. The motor part 28 may be adapted non-turnably inside an existing traffic sign post whereby the motor part 28 cannot turn inside the traffic sign post. The motor part 28 may be elongated, and the turning flange part 29 fixed thereto may be non-turnably fastened to the bottom part of the base post 30. The fastening may make use of bearing of different kinds. The flange part 29 may extend on the outside of the hole edges at the upper part of the traffic sign post. When the motor is running, it may turn the base post 30 and the sign part 31 attached thereto by means of the flange part 29.

An exemplary embodiment comprises an arrangement in a traffic sign for replacing a plate part 4a, 4b included therein, whereby the traffic sign comprises a plurality of mutually different plate parts 4a, 4b, one of which at a time may be exchanged visible and directed on a traffic route, a base post 30 of the traffic sign, most suitably a vertical post, on which may be adapted, by means of at least one bearing 11, 12, a sign part 31 which is turnable by means of a power device, and said sign part 31 comprises at least two different plate parts 4a, 4b aligned in different directions, whereby a desired plate part of said plate parts is turnable to the direction of the traffic route by means of said power device, and that the traffic sign includes one or more cover parts 6 which cover those plate parts 4a or 4b which are not meant to control traffic.

According to an exemplary embodiment, the sign part 31 comprises at least two plate parts 4a and 4b as well as a band 5, and they form a flat and turnable structure around the base post 30.

According to an exemplary embodiment, the cover part 6 is fastened to the base post 30 and adapted to give way rearward, thereby allowing the structure that includes plate parts 4a, 4b to turn by at least 180° to replace the plate part 4a, 4b with another plate part.

According to an exemplary embodiment, the cover part 6 is adapted to withdraw by the necessary distance against the spring means adapted in connection with the arm 3 and fastening part 2 of the plate part 6 as the traffic sign is turning by means of the power device and pushing the cover part 6 to the withdrawing movement.

According to an exemplary embodiment, the traffic sign is provided with a control centre 17 receiving signals, whereby the traffic sign may be turned by means of a power device controlled by remote control.

According to an exemplary embodiment, the traffic sign is electrified either from the electrical network or by means of solar or wind power, or battery energy.

According to an exemplary embodiment, there are three plate parts 4a, 4b at an angle of 120° in relation to each other, and two of them are coved by means of withdrawing cover parts.

According to an exemplary embodiment, the sign part 31 is adapted turnable by means of a power device and power transmission system adapted thereto.

According to an exemplary embodiment, the power transmission system comprises a cog wheel gear 8, 9, a belt system, pneumatic, hydraulic, or chain system.

According to an exemplary embodiment, the arrangement comprises a sensor 19 adapted to control the turning of the traffic sign.

According to an exemplary embodiment, the bearing 11, 12 comprises a sliding, ball, needle or conical bearing.

According to an exemplary embodiment, the sliding bearing comprises a sleeve 20, washer 21, and sliding part 22.

According to an exemplary embodiment, the arrangement additionally comprises an illumination system, heater and/or thermostat.

According to an exemplary embodiment, the arrangement is adapted for installation on an existing traffic sign post.

According to an exemplary embodiment, the arrangement is adapted for installation on an existing traffic sign post by means of a power device.

According to an exemplary embodiment, the base post 30 comprises a first and second body part 1, 10, where there is, adapted as an extension to the first body part 1 by at least one bearing 11, 12, a second body part 10 which is turnable by means of a power device, and to which second body part 10 there are connected at least two 4a, 4b different plate parts directed in different directions, whereby the desired plate part of said plate parts 4a, 4b is turnable in the direction of the traffic route by means of said power device.

Those skilled in the art will find it obvious that, as technology advances, the basic idea of the invention may be implemented in many different ways. The invention and its embodiments are thus not restricted to the examples described above but may vary within the scope of the claims.

1. An arrangement in a traffic sign for replacing a plate part included therein, whereby the traffic sign comprises a plurality of mutually different plate parts, one of which at a time may be exchanged visible and directed on a traffic route, a base post of the traffic sign, most suitably a vertical post, a sign part, and a power device, on which base post is adapted, by means of at least one bearing, theft sign part which is turnable by means of theft power device, wherein said sign part comprises at least two different plate parts aligned in different directions, whereby a desired plate part of said plate parts is turnable to the direction of the traffic route by means of said power device, and the traffic sign includes one or more cover parts which cover those plate parts or which are not meant to control traffic.

2. An arrangement according to claim 1, wherein the sign part comprises at least two plate parts and as well as a band, and they form a flat and turnable structure around the base post.

3. An arrangement according to claim 1, wherein the cover part is fastened to the base post and adapted to give way rearward, thereby allowing the structure that includes plate parts to turn by at least 180° to replace the plate part with another one.

4. An arrangement according to claim 3, wherein the cover part is adapted to withdraw by the necessary distance against a spring means adapted in connection with an arm and a fastening part of the coverer part as the traffic sign is turning by means of the power device and pushing the cover part to the withdrawing movement.

5. An arrangement according to claim 1, wherein the traffic sign is provided with a control centre which receives signals, whereby the traffic sign is turnable by means of a power device controlled by remote control.

6. An arrangement according to claim 1, wherein the traffic sign is electrified either from the electrical network or by means of solar or wind power, or battery energy.

7. An arrangement according to claim 1, wherein there are three plate parts at an angle of 120° in relation to each other, and two of them are covered by means of withdrawing cover parts.

8. An arrangement according to claim 1, wherein the sign part is adapted turnable by means of a power device and power transmission system adapted thereto.

9. An arrangement as claimed in claim 8, wherein the power transmission system comprises a cog wheel gear, a belt system, a pneumatic, hydraulic, or chain system.

10. An arrangement according to claim 1, wherein characterised in that the arrangement comprises a sensor adapted to adjust the turning of the traffic sign.

11. An arrangement according to claim 1, wherein the bearing comprises a sliding, ball, needle, or conical bearing.

12. An arrangement according to claim 1, wherein the arrangement additionally comprises an illumination system, heater and/or thermostat.

13. An arrangement according to claim 1, wherein the arrangement is adapted to be installed on an existing traffic sign post.

14. An arrangement according to claim 13, wherein the arrangement is adapted to be installed on an existing traffic sign post by means of a power device.

15. An arrangement according to claim 1, wherein the base post comprises a first and second body part, where there is, adapted as an extension to the first body part by at least one bearing, the second body part which is turnable by means of a power device, and to which second body part there are connected at least two different plate parts directed in different directions, whereby the desired plate part of said plate parts is turnable in the direction of the traffic route by means of said power device.
